(19) United States
(12) Patent Application Publication
(10) Pub. No.: US 2017/0368686 A1
(43) Pub. Date: Dec. 28, 2017

(54) METHOD AND DEVICE FOR AUTOMATIC OBSTACLE AVOIDANCE OF ROBOT

(71) Applicant: Qihan Technology Co., Ltd., Shenzhen (CN)

(72) Inventors: Lvde Lin, Shenzhen (CN); Yongjun Zhuang, Shenzhen (CN)

(21) Appl. No.: 15/239,872

(22) Filed: Aug. 18, 2016

(30) Foreign Application Priority Data
Jun. 28, 2016 (CN) 201610485153.9

(51) Int. Cl. B25J 9/16; G05D 1/02

(52) U.S. Cl. CPC B25J 9/1676; G05D 1/0214; Y10S 901/01

(57) ABSTRACT

The present invention provides a method for automatic obstacle avoidance of a robot, and this method comprises: according to a depth sensor, obtaining depth data of movable areas of a scene in which the robot lies in; according to a preset depth threshold value, binarizing the depth data; according to an average value or a sum value of binarization processing result of areas, identifying an area where the robot is farther away from an obstacle as a moving direction of the robot. In the present invention, since the depth data is collected, no measurement dead zone is prone to occur; moreover, calculating the average value or the sum value of the binarized depth data only needs to perform a simple comparison, the processing is simpler, the processing speed is fast, and the requirement of the system and the cost are lower.

### FIELD OF THE INVENTION

The present invention relates to the technical field of robots, and more particularly to a method for automatic obstacle avoidance of a robot.

### BACKGROUND

With the improvement of the intelligent control technology, more and more intelligent robots have entered the people's living. For example, home service robots, such as a sweeping robot, a window cleaning robot, and so on, can help the people finish daily ground sweeping or window cleaning works automatically and high-efficiently, and thus bring much convenience to the people's living.

During a working process of a home service robot, the robot usually needs to move indoors or outdoors automatically. In its moving process, the robot inevitably meets various obstacles, such as furniture, a wall, a tree, and so on. As a result, when the home service robot works, how to avoid the obstacles high-efficiently and accurately is an important technical point for ensuring a service quality of the intelligent robot.

An existing home service robot mainly detects whether there is an obstacle in the front of it by a sensor, such as an ultrasonic wave sensor, an IR (Infrared Ray) sensor, a laser sensor, and so on, and a potential field algorithm is added into an obstacle avoidance algorithm to instruct the robot to avoid the obstacle. Although the prior art can achieve an automatic obstacle avoidance of the robot, when the sensor, such as the ultrasonic wave sensor or the IR sensor, is used for measuring, measurement dead zones may exist, and the measuring is prone to be affected by the environment, and thus an accuracy of obstacle avoidance may be affected; moreover, when a laser sensor is used for measuring, since the laser sensor has a high requirement for the system, a product cost of the laser sensor is high, and a processing speed of the obstacle avoidance is slow.

### BRIEF DESCRIPTION

A purpose of the present invention is providing a method for automatic obstacle avoidance of a robot, which aims at solving a problem in the prior art that when a robot automatically avoids an obstacle, an accuracy of the obstacle avoidance is not high, or that the requirement for the system is high, a product cost of the robot is high, and a processing speed is slow.

In one aspect, one embodiment of the present invention provides a method for automatic obstacle avoidance of a robot, wherein this method comprises:

according to a depth sensor, obtaining depth data of movable areas of a scene where a robot lies in;

according to a preset depth threshold value, binarizing the depth data; and

according to an average value or a sum value of binarization processing results of areas, identifying an area where the robot is currently farther away from an obstacle as a moving direction of the robot.

In combination with the first aspect, in a first possible implementation mode of the first aspect, the step of according to an average value or a sum value of binarization processing results of areas, identifying an area where the robot is currently farther away from an obstacle as a moving direction of the robot comprises:

dividing the movable areas of the scene where the robot lies in into a preset number of areas;

according to the binarized depth data, calculating an average value or a sum value of the preset number of areas;

according to a comparison result of the average value or the sum value, identifying the area where the robot is currently farther away from the obstacle as the moving direction of the robot.

In combination with the first aspect, in a second possible implementation mode of the first aspect, the step of according to an average value or a sum value of binarization processing results of areas, identifying an area where the robot is currently farther away from an obstacle as a moving direction of the robot comprises:

dividing the movable areas of the scene where the robot lies in into a preset number of areas according to a plurality of different ways;

calculating the average value or the sum value of the binarized depth data in the areas divided according to the plurality of different ways;

according to a comparison result of the average value or the sum value, identifying the area where the robot is currently farther away from the obstacle as the moving direction of the robot.

In combination with the first aspect, the first possible implementation mode of the first aspect, or the second possible implementation mode of the first aspect, in a third possible implementation mode of the first aspect, the step of binarizing the depth data according to a preset depth threshold value comprises:

comparing obtained depth data with the preset depth threshold value, if the obtained depth data is greater than the preset depth threshold value, assigning a value of 1; if the obtained depth data is less than the preset depth threshold value, assigning a value of 0.

In combination with the first aspect, in a fourth possible implementation mode of the first aspect, before the step of binarizing the depth data according to a preset depth threshold value, the method further comprises:

calculating an average depth value according to the obtained depth data, and using the calculated average depth value as the depth threshold value.

In a second aspect, another embodiment of the present invention provides a device for an obstacle avoidance of a robot, wherein the device comprises:

a depth data obtaining unit configured for obtaining depth data of movable areas of a scene where the robot lies in according to a depth sensor;

a binarization processing unit configured for binarizing the depth data according to a preset depth threshold value; and

a moving unit configured for according to an average value or a sum value of binarization processing results of areas, identifying an area where the robot is currently farther away from an obstacle as a moving direction of the robot.

In combination with the second aspect, in a first possible implementation mode of the second aspect, the moving unit further comprises:

a first area dividing subunit configured for dividing the movable areas of the scene where the robot lies in into a preset number of areas;

a first calculating subunit configured for calculating an average value or a sum value of the preset number of areas according to the binarized depth data; and

a first direction determining subunit configured for identifying the area where the robot is currently farther away from the obstacle as the moving direction of the robot according to a comparison result of the average value or the sum value.

In combination with the second aspect, in a second possible implementation mode of the second aspect, the moving unit comprises:

a second area diving subunit configured for dividing the movable areas of the scene where the robot lies in into the preset number of areas by a plurality of ways;

a second calculating subunit configured for calculating the average value or the sum value of the binarized depth data in the areas divided by the plurality of ways; and

a second direction determining subunit configured for identifying the area where the robot is currently farther away from the obstacle as the moving direction of the robot according to the comparison result of the average value or the sum value.

In combination with the second aspect, the first possible implementation mode of the second aspect, or the second possible implementation mode of the second aspect, in a third possible implementation mode of the second aspect, the binarization processing unit is specifically configured for:

comparing obtained depth data with the preset depth threshold value; if the obtained depth data is greater than the preset depth threshold value, a value of 1 is assigned; if the obtained depth data is less than the preset depth threshold value, a value of 0 is assigned.

In combination with the second aspect, in a fourth possible implementation mode of the second aspect, the device further comprises:

a depth threshold value determining unit configured for calculating an average depth value according to the obtained depth data and using the average depth value as the depth threshold value.

In the present invention, depth data in the movable areas of the scene where the robot lies in is obtained, the obtained depth data is then binarized according to the preset depth threshold value, the average value or the sum value of the binarized areas are calculated, and according to the average value or the sum value, the area where the robot is currently farther away from the obstacle can be identified as the moving direction of the robot. In the present invention, since the depth data is collected, no dead zone is prone to occur; moreover, calculating the average value or the sum value of the binarized depth data only needs to perform a simple comparison, the processing is simpler, the processing speed is fast, and the requirement for the system and the cost are lower.

### BRIEF DESCRIPTION OF THE DRAWINGS

FIG. 1 is an implementation flow chart of a method for automatic obstacle avoidance of a robot provided by a first embodiment of the present invention.

FIG. 2 is an implementation flow chart of a method for automatic obstacle avoidance of a robot provided by a second embodiment of the present invention.

FIG. 3 is an implementation flow chart of a method for automatic obstacle avoidance of a robot provided by a third embodiment of the present invention.

FIG. 4 is a structural schematic view of a device for automatic obstacle avoidance of a robot provided by a fourth embodiment of the present invention.

### DETAILED DESCRIPTION

In order to make the purposes, technical solutions, and advantages of the present invention be clearer and more understandable, the present invention will be further described in detail hereafter with reference to the accompanying drawings and embodiments. It should be understood that the embodiments described herein are only intended to illustrate but not to limit the present invention.

A purpose of the embodiments of the present invention is providing a method for automatic obstacle avoidance of a robot, which aims at solving a problem in the prior art that when a robot detects an obstacle, using an IR (Infrared Ray) sensor or an ultrasonic wave to detect may generate a detection dead zone, moreover, the detection is prone to be affected by the environment, and an accuracy of obstacle avoidance may be affected; or that when a laser sensor is used for measuring, since the laser sensor has a high requirement for the system, product cost may be increased, a process of the obstacle avoidance is complicated, the processing speed is slow, thereby resulting in a low efficiency of the obstacle avoidance.

The present invention will be further described hereafter with reference to the accompanying drawings.

### Embodiment I

FIG. 1 shows an implementation flow chart of a method for automatic obstacle avoidance of a robot provided by a first embodiment of the present invention, which is described in detail as follows:

In a step S101, according to a depth sensor, obtaining depth data of movable areas of a scene where the robot lies in.

Specifically, the depth sensor described in the embodiment of the present invention can be a 3D (three dimensional) sensor, for example, binocular cameras can be used to collect images respectively; according to preset parameters of the binocular cameras and difference information among the images, the depth data of objects in the images is obtained.

The movable areas of the scene where the robot lies in is actually a plane where the robot lies in, such as the plane where a sweeping robot lies in, that is, the ground where the robot is located; as for a window cleaning robot, it is actually a glass plane wherein the robot is located. The movable areas can be generally any direction of 360 degree directions in the plane where the robot lies in.

The depth data is actually a distance value between an object in an image and the robot. According to the depth sensor, depth data of each pixel point in the image of the scene where the robot lies in can be obtained.

In a step S102, according to a preset depth threshold value, binarizing the depth data.

Specifically, as to the depth threshold value in the embodiment of the present invention, a depth threshold value matching with the scene where the robot lies in can be selected according to different scenes where the robot lies in. For example, in a crowded environment, such as a bedroom, a depth threshold value with a smaller numerical value can be selected; however, in a broader environment, a depth threshold value with a bigger numerical number can be set.

When the obtained depth data is binarized according to selected data, according to a simple comparison, a binarization result corresponding to each depth data can be obtained.

For example, a binarization result of obtained depth data of which a numerical number is greater than the depth threshold value is set to be 1, and a binarization result of obtained depth data of which a numerical number is less than the depth data is set to be 0. In that way, with respect to the obtained depth data, all of them can be represented by a series of numerical numbers “0” and numerical numbers “1”.

Of course, the aforesaid representation mode is only one of the implementation modes of the present invention; the binarization result of the obtained depth data of which the numerical number is less than the depth threshold value can also be set to be 1, and the binarization result of the obtained depth data of which the numerical number is greater than the depth threshold value can be set to be 0. It is not specifically limited here.

In a step S103, according to an average value or a sum value of binarization processing result of areas, identifying an area where the robot is currently farther away from an obstacle as a moving direction of the robot.

After a determination of binarization data corresponding to the depth data of the movable areas in the scene where the robot lies in, a depth value of an area corresponding to any movable direction of the robot can be calculated; for example, according to the binarized depth data that is represented by “0” and “1”, an average value or a sum value of the binarized depth value of an area corresponding to any movable direction of the robot can be calculated very rapidly.

For example, when a binarized depth value “1” represents that the numerical value of the obtained depth data is greater than the depth threshold value, the greater the average value or the sum value, the greater the distance between the obstacle and the robot, and it can be inferred that the robot can avoid the obstacle more effectively.

In the present invention, the depth data of the movable areas of the scene where the robot lies in is obtained, the depth data is then binarized according to the preset depth threshold value, the average value or the sum value of the binarized areas is calculated, and according to the calculated average value or the sum value, the area where the robot is currently farther away from the obstacle can be identified as the moving direction. In the present invention, since the depth data is collected, no detection dead zone is prone to occur; moreover, calculating the average value or the sum value of the binarized depth data only needs to perform a simple comparison, the processing is simpler, the processing speed is fast, and the requirement for the system and the cost are lower.

### Embodiment II

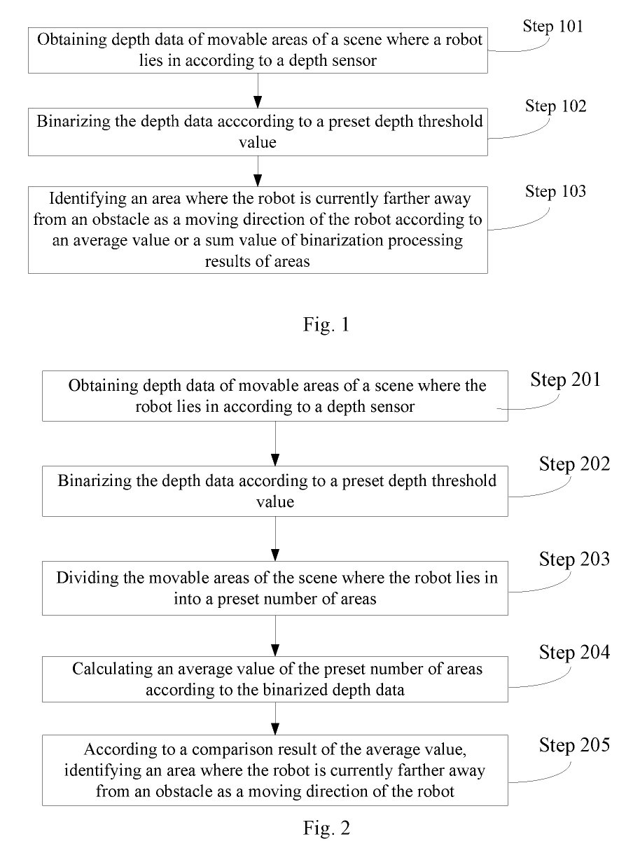

FIG. 2 illustrates an implementation flow chart of a method for automatic obstacle avoidance of a robot provided by a second embodiment of the present invention, which is described in detail as follows:

In a step S201, according to a depth sensor, obtaining depth data of movable areas of a scene where the robot lies in.

In a step S202, according to a preset depth threshold value, binarizing the depth data.

The steps S201-S202 in this embodiment of the present invention are substantially the same as the steps S101-S102 in the embodiment I, and are not repeatedly described herein.

In the step S203, dividing the movable areas of the scene where the robot lies in into a preset number of areas.

In this embodiment of the present invention, according to a current orientation of the robot, the movable areas can be divided into a plurality of areas averagely, for example, the movable areas can be divided into 11 areas, and each of the 11 areas comprises a certain number of depth data.

Of course, in this embodiment of the present invention, there is no need to restrictedly and strictly execute the step S202 and the step S203 according to an order of priority; it is also possible that the areas are divided firstly, and then the depth data in the divided areas is binarized.

In a further preferred embodiment of the present invention, according to many different dividing methods, more abundant area diving ways can be obtained. For example, in a first dividing way, a first area is divided from the current orientation of the robot. However, a second dividing way deviates in a preset angle on the basis of the first dividing way, wherein the preset angle can be, for example, one degree. Therefore, according to the need of accuracy, more areas including different pixels can be divided, and the obtained average value or sum value of the depth may also be different.

In a step S204, according to the binarized depth data, calculating an average value or a sum value of the preset number of areas.

When the system uses a single way to divide images in the movable areas, as for binary data in the divided areas, the average value or the sum value of the binary data of the divided areas can be obtained by a rapid calculation.

When the system uses many ways to divide the images in the movable areas, due to a simple calculation of the binary data, the average value or the sum value of the binary data of the areas can also be obtained rapidly; however, due to many dividing ways, more possible areas can be included; for this reason, it is more convenient to obtain an area having a greater or less average value/sum value, and thus a forward moving direction can be determined more accurately, so that the robot can avoid the obstacle more effectively.

In a step S205, according to a comparison result of the average value or the sum value, identifying an area where the robot is currently farther away from the obstacle as a moving direction of the robot.

For example, when the binarized depth data “1” represents that a numerical number of an obtained depth data is greater than the depth threshold value, an area having a greater average value or sum value can be used as the forward moving direction of the robot, such that the robot can avoid obstacles more effectively. Similarly, when the binarized depth data “0” represents that the numerical number of the obtained depth data is greater than the threshold depth value, an area having a less average value or sum value can be used as the forward moving direction of the robot. Moreover, in the present invention, according to many area dividing ways, an accuracy of the forward moving direction can be improved more effectively.

### Embodiment III

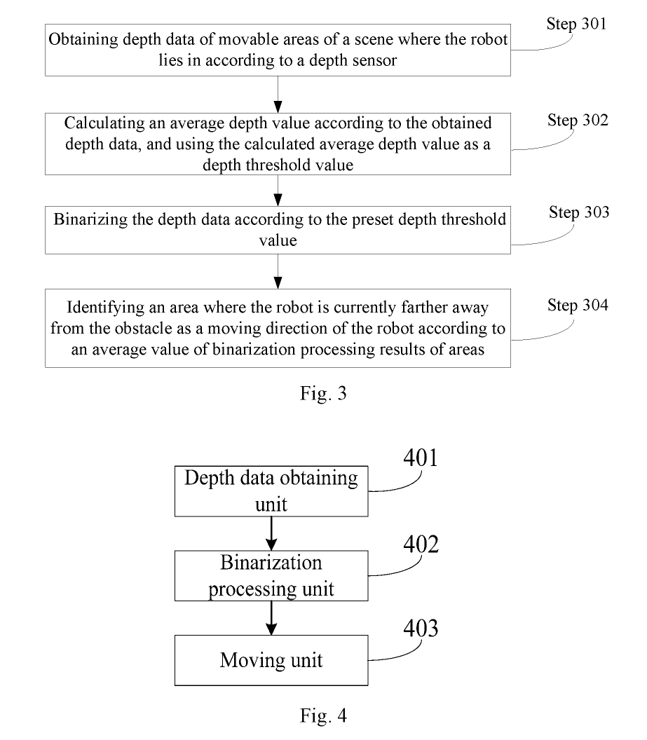

FIG. 3 illustrates an implementation flow chart of a method for automatic obstacle avoidance of a robot provided by a third embodiment of the present invention, which is described in detail in as follows:

In a step S301, according to a depth sensor, obtaining depth data of movable areas of a scene where the robot lies in.

In a step S302, according to obtained depth data, calculating an average depth value, and using the calculated average depth value as a depth threshold value.

Specifically, in order to make the robot be more self-adaptive to comparison requirements of depth values of different scenes, the present invention further comprises calculating the average value of the depth data in the scene where the robot lies in.

With respect to the average depth value described in this embodiment of the present invention, depth data of different angles can be selected by means of sampling to calculate the average value, and thus an efficiency of calculating and processing of the average depth data can be effectively improved.

In a step S303, according to the preset depth threshold value, binarizing the depth data.

In a step S304, according to an average value or a sum value of binarization processing results of areas, identifying an area where the robot is currently farther away from the obstacle as a moving direction of the robot.

This embodiment of the present invention adds a step of calculation of the depth threshold value based on the embodiment I; by selecting the average depth value in the scene as the depth threshold value, the trouble that a user needs to adjust the depth threshold value according to different scenes can be avoided; in the present invention, by a self-adaptive way, a convenience of the use of the robot can be effectively improved.

### Embodiment IV

FIG. 4 illustrates a structural schematic view of a device for automatic obstacle avoidance of a robot provided by a fourth embodiment of the present invention, which is described in detail as follows.

The device for automatic obstacle avoidance of the robot in the embodiment of the present invention comprises:

a depth data obtaining unit 401 configured for obtaining depth data of movable areas of a scene where the robot lies in according to a depth sensor;

a binarization processing unit 402 configured for binarizing the depth data according to a preset depth threshold value; and

a moving unit 403 configured for identifying an area where the robot is currently farther away from an obstacle as a moving direction of the robot according to an average value or a sum value of binarization processing results of areas.

Preferably, a first area dividing subunit, which is configured for dividing the movable areas of the scene where the robot lies in into a preset number of areas;

a first calculating subunit, which is configured for calculating an average value or a sum value of the preset number of areas according to the binarized depth data; and

a first direction determining subunit, which is configured for identifying the area where the robot is currently farther away from the obstacle is the moving direction of the robot according to a comparison result of the average value or the sum value.

Preferably, a second area diving subunit, which is configured for dividing the movable areas of the scene where the robot lies in into the preset number of areas by a plurality of ways;

a second calculating subunit, which is configured for calculating the average value or the sum value of the binarized depth data in the areas divided by the plurality of ways; and

a second direction determining subunit, which is configured for identifying the area where the robot is currently farther away from the obstacle as the moving direction of the robot according to the comparison result of the average value or the sum value.

Preferably, the binarization processing unit is specifically configured for:

comparing obtained depth data with the preset depth threshold value; if the obtained depth data is greater than the preset depth threshold value, a value of 1 is assigned; if the obtained depth data is less than the preset depth threshold value, a value of 0 is assigned.

Preferably, the device further comprises:

a depth threshold value determining unit configured for calculating an average depth value according to obtained depth data, and using the average depth value as the depth threshold value.

The device for automatic obstacle avoidance of the robot in the embodiment of the present invention corresponds to the methods for automatic obstacle avoidance of the robot in the embodiments I-III, and is not repeatedly described here.

In some embodiments provided by the present invention, it should be understood that the disclosed systems, devices and methods can be realized by other ways. For example, the device embodiment described above is merely for schematic; for example, the dividing of the units is merely a division of logic function, in an actual implementation, there can be other dividing ways; for example, a plurality of units or components can be combined or integrated into another system, or some characteristics can be ignored or not executed. In another aspect, the displayed or discussed mutual coupling, direct coupling, or communication connection can be an indirect connection or a communication connection through some interfaces, devices or units, and can be in an electrically connected form, a mechanically connected form, or other forms.

The units being described as separated parts can be or not be physically separated, the components displayed as units can be or not be physical units, that is, the components can be located at one place, or be distributed onto a plurality of network elements. According to actual requirements, some or all of the units can be selected to implement the purposes of the technical solution of the present embodiment.

In addition, in each of the embodiments of the present invention, all of the functional units can be integrated into a single processing unit; each of the units can also exists physically and independently, and two or more than two of the units can also be integrated into a single unit. The aforesaid integrated units can either be realized in the form of hardware, or be realized in the form of software functional units.

If the integrated units are implemented in the form of software functional units and are sold or used as independent products, they can be stored in a computer readable storage medium. Based on this comprehension, the technical solutions of the present invention, or the part thereof that has made contribution to the prior art, or the whole or a part of the technical solutions, can be essentially embodied in the form of software products, the computer software products can be stored in a storage medium, which comprises some instructions and is configured for instructing a computer device (which can be a personal computer, a server, a network device, or the like) to perform the whole or a part of the method in each of the embodiments of the present invention. The aforesaid storage medium comprises various mediums which can store procedure codes, such as a USB flash disk, a movable hard disk, a ROM (Read-Only Memory), A RAM (Random Access Memory), a magnetic disk, a disk, or the like.

The aforementioned embodiments are only preferred embodiments of the present invention, and should not be regarded as being any limitation to the present invention. Any modification, equivalent replacement, improvement, and so on, which are made within the spirit and the principle of the present invention, should be included within the protection scope of the present invention.

1. A method for automatic obstacle avoidance of a robot, comprising:
according to a depth sensor, obtaining depth data of movable areas of a scene where a robot lies in;
according to a preset depth threshold value, binarizing the depth data; and
according to an average value or a sum value of binarization processing results of areas, identifying an area where the robot is currently farther away from an obstacle as a moving direction of the robot.

2. The method according to claim 1, wherein, a step of according to an average value or a sum value of binarization processing results of areas, identifying an area where the robot is currently farther away from an obstacle as the moving direction of the robot comprises:
dividing the movable areas of the scene where the robot lies in into a preset number of areas;
according to the binarized depth data, calculating an average value or a sum value of the preset number of areas;
according to a comparison result of the average value or the sum value, identifying the area where the robot is currently farther away from the obstacle as the moving direction of the robot.

3. The method according to claim 1, wherein, a step of according to an average value or a sum value of areas of binarization processing results, identifying an area where the robot is currently farther away from an obstacle as a moving direction of the robot comprises:
dividing the movable areas of the scene where the robot lies in into a preset number of areas according to a plurality of different ways;
calculating the average value or the sum value of the binarized depth data in the areas divided by the plurality of different ways;
according to a comparison result of the average value or the sum value, identifying the area where the robot is currently farther away from the obstacle as the moving direction of the robot.

4. The method according to claim 1, wherein, a step of binarizing the depth data according to a preset depth threshold value comprises:
comparing obtained depth data with the preset depth threshold value, if the obtained depth data is greater than the preset depth threshold value, assigning a value of 1; if the obtained depth data is less than the preset depth threshold value, assigning a value of 0.

5. The method according to claim 1, wherein, before the step of binarizing the depth data according to a preset depth threshold value, the method further comprises:
calculating an average depth value according to the obtained depth data, and using the calculated average depth value as the depth threshold value.

6. A device for automatic obstacle avoidance of a robot, comprising:
a depth data obtaining unit configured for obtaining depth data of movable areas of a scene where the robot lies in according to a depth sensor;
a binarization processing unit configured for binarizing the depth data according to a preset depth threshold value; and
a moving unit configured for according to an average value or a sum value of binarization processing results of areas, identifying an area where the robot is currently farther away from an obstacle as a moving direction of the robot.

7. The device according to claim 6, wherein, the moving unit further comprises:
a first area dividing subunit configured for dividing the movable areas of the scene where the robot lies in into a preset number of areas;
a first calculating subunit configured for calculating an average value or a sum value of the preset number of areas according to the binarized depth data; and
a first direction determining subunit configured for identifying the area where the robot is currently farther away from the obstacle as the moving direction of the robot according to a comparison result of the average value or the sum value.

8. The device according to claim 6, wherein, the moving unit comprises:
a second area diving subunit configured for dividing the movable areas of the scene where the robot lies in into the preset number of areas by a plurality of ways;
a second calculating subunit configured for calculating the average value or the sum value of the binarized depth data in the areas divided by the plurality of ways; and
a second direction determining subunit configured for identifying the area where the robot is currently farther away from the obstacle as the moving direction of the robot according to the comparison result of the average value or the sum value.

9. The device according to claim 6, wherein, the binarization processing unit is specifically configured for:
comparing obtained depth data with the preset depth threshold value; if the obtained depth data is greater than the preset depth threshold value, a value of 1 is assigned; if the obtained depth data is less than the preset depth threshold value, a value of 0 is assigned.

10. The device according to claim 6, further comprising:
a depth threshold value determining unit configured for calculating an average depth value according to the obtained depth data and using the average depth value as the depth threshold value.
